(19) United States
(12) Patent Application Publication
(10) Pub. No.: US 2024/0345219 A1
(43) Pub. Date: Oct. 17, 2024

(54) NETWORK-ASSISTED CLUTTER IDENTIFICATION

(71) Applicant: QUALCOMM Incorporated, San Diego, CA (US)

(72) Inventors: Yucheng DAI, San Diego, CA (US); Wooseok NAM, San Diego, CA (US); Tao LUO, San Diego, CA (US)

(21) Appl. No.: 18/300,128

(22) Filed: Apr. 13, 2023

(51) Int. Cl. G01S 7/41; G01S 7/00; G01S 13/00; G01S 13/56; H04W 24/08

(52) U.S. Cl. CPC G01S 7/411; G01S 7/006; G01S 13/003; G01S 13/56; H04W 24/08

(57) ABSTRACT

Apparatuses and methods for network-assisted clutter identification are described. An apparatus is configured to obtain environmental information associated with a sensing environment, and to detect, during a sensing operation, a set of objects in the sensing environment. The apparatus is configured to process data for a target object(s) in the set of objects or filter data for an unintended object(s) in the set of objects based on the environmental information that indicates characteristics associated with the set of objects in the sensing environment. Another apparatus is configured to provide environmental information associated with a sensing environment. Environmental information indicates characteristics associated with a set of objects in the sensing environment; the set of objects in the sensing environment includes a target object (a) and an unintended object(s). The another apparatus is configured to receive a sensing indication that corresponds to a sensing operation having sensing information associated with the target object(s).

### TECHNICAL FIELD

The present disclosure relates generally to communication systems, and more particularly, to wireless communications utilizing sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to obtain environmental information associated with a sensing environment. The apparatus is also configured to detect, during a sensing operation, a set of objects in the sensing environment. The apparatus is further configured to process data for at least one target object in the set of objects or filter data for at least one unintended object in the set of objects based on the environmental information, where the environmental information indicates at least one characteristic associated with the set of objects in the sensing environment.

In the aspect, the method includes obtaining environmental information associated with a sensing environment. The method also includes detecting, during a sensing operation, a set of objects in the sensing environment. The method further includes processing data for at least one target object in the set of objects or filtering data for at least one unintended object in the set of objects based on the environmental information, where the environmental information indicates at least one characteristic associated with the set of objects in the sensing environment.

In an aspect of the disclosure, a method, a computer-readable medium, and an apparatus are provided. The apparatus is configured to provide, for a user equipment (UE), environmental information associated with a sensing environment, where the environmental information indicates at least one characteristic associated with a set of objects in the sensing environment, where the set of objects in the sensing environment includes at least one target object and at least one unintended object. The apparatus is also configured to receive, from the UE, a sensing indication that corresponds to a sensing operation, where the sensing indication includes sensing information associated with the at least one target object of the set of objects in the sensing environment based on the at least one target object.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of radio frequency (RF) sensing.

FIG. 6 is a call flow diagram for wireless communications, in accordance with various aspects of the present disclosure.

FIG. 7 is a diagram illustrating an example of network assisted clutter identification in RF sensing, in accordance with various aspects of the present disclosure.

FIG. 8 is a diagram illustrating an example of network assisted clutter identification in RF sensing, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks, such as a 5G NR network, may enable location detection of device-free objects via NR-based sensing. For example, RF sensing may be utilized for such location detection. RF sensing may be regarded as consumer-level radio detection and ranging (RADAR) with advanced detection capabilities. RF sensing may enable touchless/device-free interaction with a device and/or system, and RF waveforms may be utilized for communications (e.g., 3GPP NR) and for sensing applications. For instance, millimeter wave (mmWave or mmW) RF signals (e.g., 3GPP NR frequency range (FR) 2 (FR2)/FR2x/FR4) may be utilized for range (distance) detection. In different applications, RF sensing may be used for health monitoring (e.g., heartbeat detection, respiration rate monitoring, etc.), gesture recognition (e.g., human activity recognition, keystroke detection, sign language recognition, etc.), contextual information acquisition (e.g., location detection/tracking, direction finding, range estimation, etc.), automotive/unmanned aerial vehicle RADAR (e.g., smart cruise control, collision avoidance, routing, etc.), and/or the like.

However, in wireless sensing (e.g., mono-static or bi-static), a UE can detect a large number of multipaths from a given sensing channel. For example, reflection from intended/target object(s), such as a large object, may have different reflection points and thus generate multiple clustered paths. As another example, reflection from unintended/non-target object(s) (e.g., clutter associated with reflections from non-target objects) may be unwanted reflections, such as reflections from ground and buildings, and may even be stronger than the desired reflection from the intended/target object(s). Unintended/non-target object(s) may be differentiated from the intended/target object(s) in material, size, volume, RADAR cross-section (RCS), relative position to UE (e.g., angle of arrival (AoA)/expected delay), movement/speed (e.g., Doppler/micro-Doppler), etc. As yet another example, the reflection from surroundings may be inevitably affecting sensing functions. That is, if it is desired to detect a specific object (e.g., an intended/target object), reflection from other surroundings may be interference for sensing functions and may be skipped or left out of processing/reporting for sensing operations/functions. Other sensing related functions, e.g., RF fingerprint based positioning or simultaneous localization and mapping (SLAM), may rely on the reflection(s) from surroundings to work.

Various aspects relate generally to wireless communications systems and sensing operations for wireless devices. Some aspects more specifically relate to network assisted clutter identification, e.g., in RF sensing. In one example, a UE may obtain environmental information associated with a sensing environment and may also detect, during a sensing operation, a set of objects in the sensing environment. The UE may further process data for at least one target object in the set of objects and/or or filter data for at least one unintended object in the set of objects based on the environmental information, where the environmental information indicates at least one characteristic associated with the set of objects in the sensing environment. In an additional example, a network node (e.g., a base station, a portion thereof, and/or the like) may provide, for a UE, environmental information associated with a sensing environment, where the environmental information indicates at least one characteristic associated with a set of objects in the sensing environment, and where the set of objects in the sensing environment includes at least one target object and at least one unintended object. The network node may also receive, from the UE, a sensing indication that corresponds to a sensing operation, where the sensing indication includes sensing information associated with the at least one target object of the set of objects in the sensing environment based on the at least one target object.

Particular aspects of the subject matter described in this disclosure can be implemented to realize one or more of the following potential advantages. In one example, by utilizing pre-knowledge associated with the environment of a UE from the network, the described techniques can be used to improve detection and locking of target objects for sensing, while filtering out other reflections of unintended/non-target objects, by a UE running a sensing engine (e.g., for monostatic sensing), which provides for increased sensing accuracy, reductions in power usage, and reductions in processing cycles. In another example, by filtering out reflections of unintended/non-target objects by a UE, the described techniques can be used to reduce the number of paths to be reported for the network running a sensing engine (e.g., for bistatic sensing with the UE as the receiver (Rx)), which reduces the resources used for reporting.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

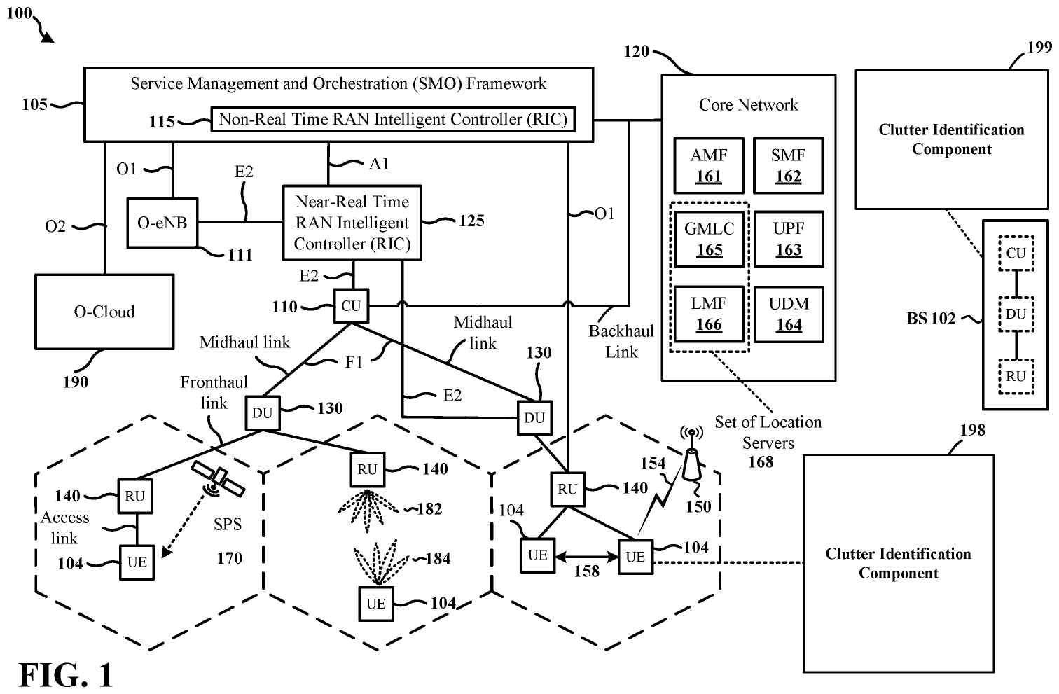

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a clutter identification component 198 (“component 198”) that may be configured to obtain environmental information associated with a sensing environment. The component 198 may also be configured to detect, during a sensing operation, a set of objects in the sensing environment. The component 198 may be further configured to process data for at least one target object in the set of objects or filter data for at least one unintended object in the set of objects based on the environmental information, where the environmental information indicates at least one characteristic associated with the set of objects in the sensing environment. The component 198 may also be configured to provide, for a network node, a request for the environmental information via at least one of first RRC signaling, a first MAC-CE, or UCI. The component 198 may also be configured to sense the at least one target object during the sensing operation in the sensing environment. The component 198 may also be configured to process the at least one target object based on the sensing operation. The component 198 may also be configured to provide, for a network node, a sensing indication that includes sensing information associated with the at least one target object based on the processed at least one target object. The component 198 may also be configured to output an indication of the processed data for the at least one target object or the filtered data for the at least one unintended object. In certain aspects, the base station 102 may have a clutter identification component 199 (“component 199”) that may be configured to provide, for a UE, environmental information associated with a sensing environment, where the environmental information indicates at least one characteristic associated with a set of objects in the sensing environment, where the set of objects in the sensing environment includes at least one target object and at least one unintended object. The component 199 may also be configured to receive, from the UE, a sensing indication that corresponds to a sensing operation, where the sensing indication includes sensing information associated with the at least one target object of the set of objects in the sensing environment based on the at least one target object. The component 199 may be configured to receive, from the UE, a request for the environmental information via at least one of first RRC signaling, a first MAC-CE, or UCI. The component 199 may be configured to receive a data indication of processed data for the at least one target object or filtered data for the at least one unintended object. That is, aspects for network assisted clutter identification, e.g., in RF sensing, may provide for increased sensing accuracy, reductions in power usage, and reductions in processing cycles by utilizing pre-knowledge associated with the environment of a UE from the network to improve detection and locking of target objects for sensing, while filtering out other reflections of unintended/non-target objects, by a UE running a sensing engine. The aspects herein, such as for network assisted clutter identification, e.g., in RF sensing, may also provide for reductions in the resources used for reporting by filtering out reflections of unintended/non-target objects by a UE to reduce the number of paths to be reported for the network running a sensing engine.

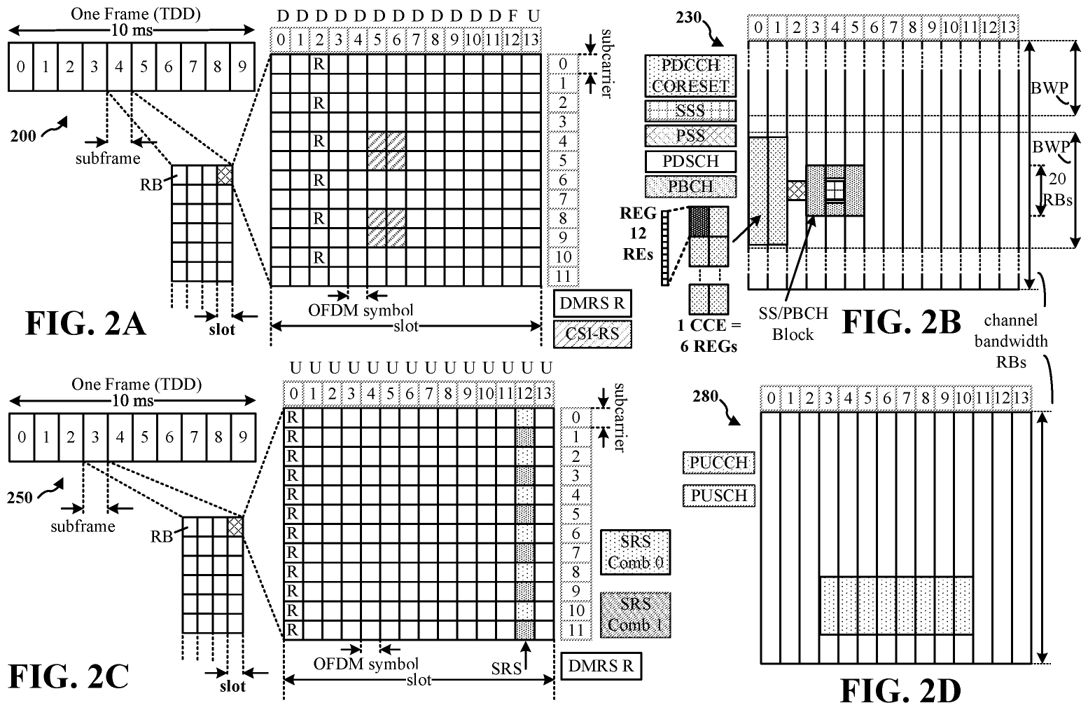

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

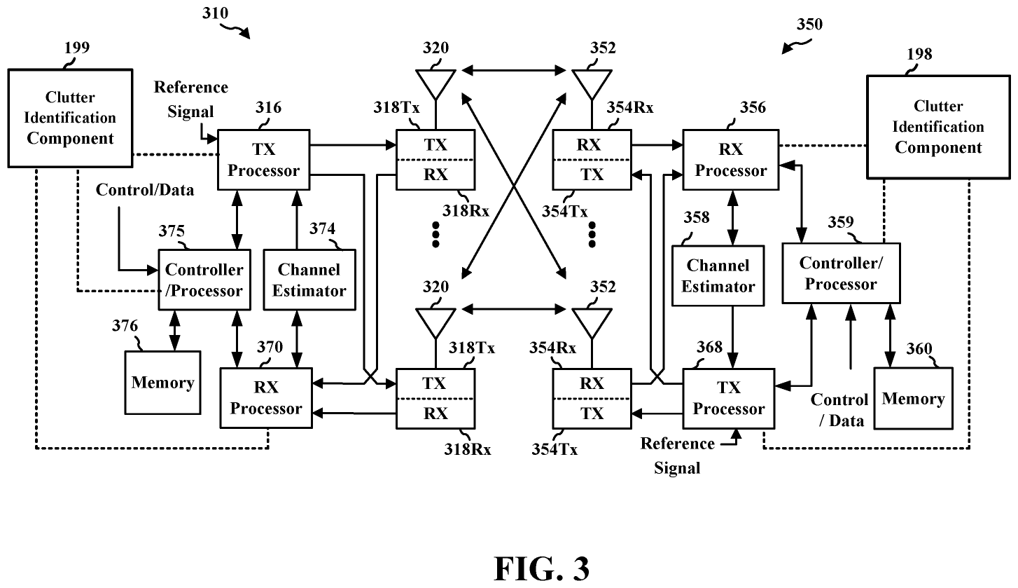

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

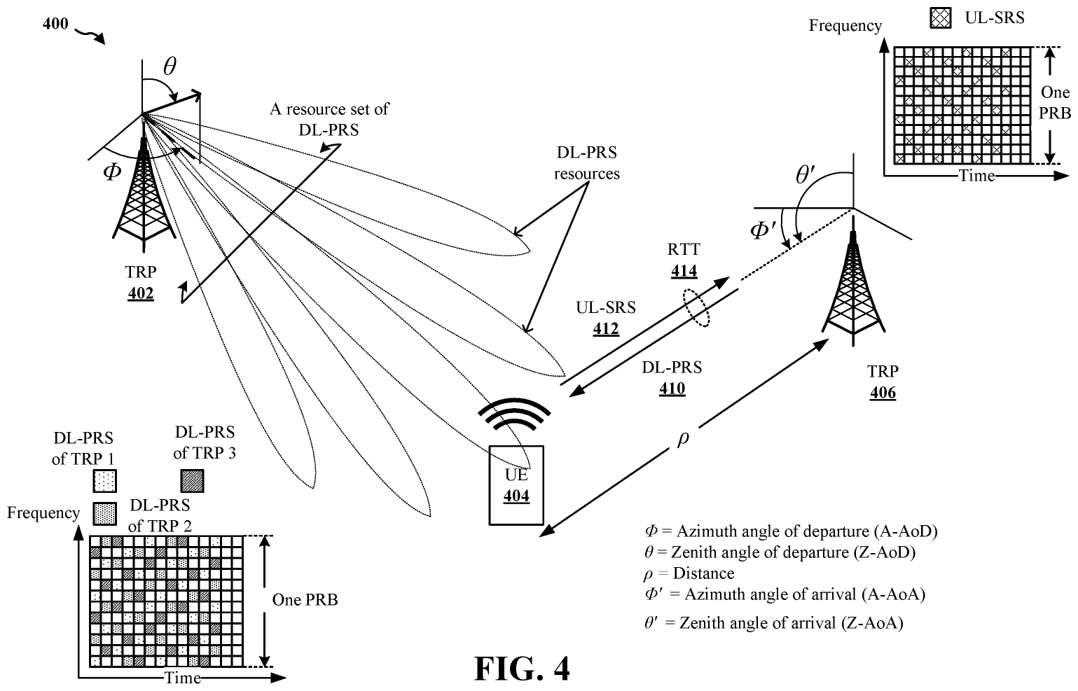

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a UE, an AP, etc.) may also be configured to include sensing capabilities, where the wireless device may be able to sense (e.g., detect and/or track) one or more objects or target entities (or objects) of an area or in an environment, including users and other people, based on radio frequencies/RADAR. An environment may refer to a particular geographical area or place, especially as affected by human activity, or the circumstances, objects, or conditions by which one is surrounded. For example, a wireless device may include a RADAR capability (which may be referred to as “RF sensing” and/or “cellular-based RF sensing), where the wireless device may transmit reference signals (e.g., RADAR reference signals (RRSs)) and measure the reference signals reflected from one or more objects (e.g., structures, walls, living objects, poses/gestures of users, and/or other things in an environment, etc.). Based on the measurement, the wireless device may determine or estimate a distance between the wireless device and the one or more objects and/or obtain environmental information associated with its surrounding including, but without limitation, range, Doppler, and/or angle information of sensing target entities. In another example, a first wireless device may receive signals transmitted from a second wireless device, where the first wireless device may determine or estimate a distance between the first wireless device and the second wireless device based on the received signals. For example, a tracking device (e.g., a Bluetooth™ tracker, an item tracker, an asset tracking device, etc.) may be configured to regularly transmit signals (e.g., beacon signals) or small amounts of data to a receiving device, such that the receiving device may be able to monitor the location or the relative distance of the tracking device. As such, a user may be able to track the location of an item (e.g., a car key, a wallet, a remote control, etc.) by attaching the tracking device to the item. For purposes of the present disclosure, a device/apparatus that is capable of performing sensing (e.g., transmitting and/or receiving signals for detecting at least one object or for estimating the distance between the device and the at least one object) may be referred to as a “sensing device,” a “sensing node,” or a “sensing entity.” For example, a sensing device may be a UE, an AP device (e.g., a Wi-Fi router), a base station, a component of the base station, a TRP, a device capable of performing radar functions, etc. Furthermore, a target entity may be any object (e.g., a person, a vehicle, a UE, etc.) for which a positioning or sensing session is performed, for example, to determine a location thereof, a velocity thereof, a heading thereof, a physiological characteristic thereof, etc. In addition, a device/apparatus that is capable of transmitting signals to a sensing device for the sensing device to determine the location or the relative distance of the device/apparatus may be referred to as a “tracking device,” a “tracker,” or a “tag.”

For purposes of the present disclosure, a positioning session may be referred to the transmitting, the receiving, and the measuring of reference signals for the purposes of determining a positioning result or state (e.g., a location, a heading, a velocity, etc.) of a target entity. A sensing session may be referred to the transmitting, the receiving, and the measuring of reference signals for the purposes of determining a sensing result or state of an environment in which the target entity is included (e.g., a change in the environment), at least one physiological characteristic of a target entity, a location of the target entity, a velocity of the target entity, a heading of the target entity, etc. A sensing session may be performed over one or more sensing occasions, where an individual sensing occasion may be a length of time in which sensing resources (e.g., frequency-modulated continuous-wave (FMCW) bandwidth, OFDM bandwidth, etc.) may be available for sensing operations.

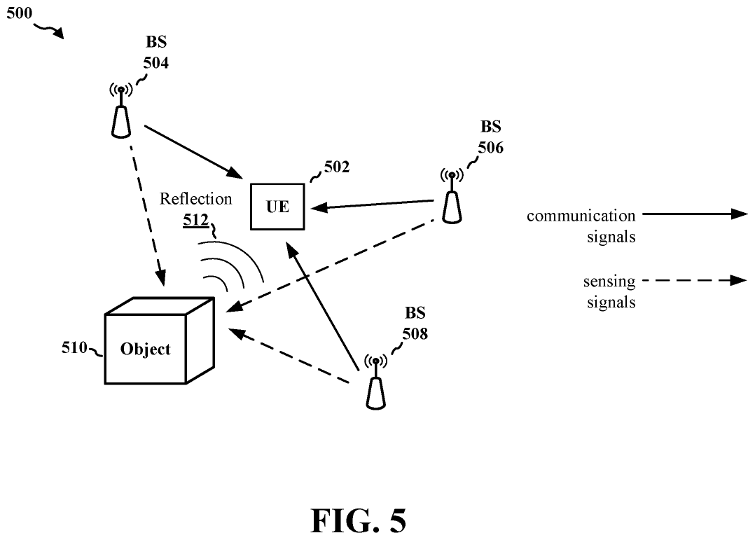

FIG. 5 is a diagram 500 illustrating an example of RF sensing. As shown in diagram 500, a UE 502 may communicate with one or more base stations, e.g., a base station 504, a base station 506, and a base station 508. A target object 510 may be sensed during a sensing session/operation to determine its sensing characteristics: e.g., location, heading, velocity, a physiological characteristic thereof, gestures, and/or the like. One or more of the base station 504, the base station 506, and/or the base station 508 may transmit sensing signals which may be reflected by the target object 510 as reflections 512. The UE 502 may receive/obtain the reflections 512 to determine one or more of the sensing characteristics for the target object 510.

RF sensing may be utilized to enable location detection of device-free objects. RF sensing may be regarded as consumer-level RADAR with advanced detection capabilities. RF sensing may enable touchless/device-free interaction with a device and/or system, and RF waveforms may be utilized for communications (e.g., 3GPP NR) and for sensing applications. For instance, mmWave RF signals (e.g., 3GPP NR FR2/FR2x/FR4) may be utilized for range (distance) detection. In different applications, RF sensing may be used for health monitoring (e.g., heartbeat detection, respiration rate monitoring, etc.), gesture recognition (e.g., human activity recognition, keystroke detection, sign language recognition, etc.), contextual information acquisition (e.g., location detection/tracking, direction finding, range estimation, etc.), automotive/unmanned aerial vehicle RADAR (e.g., smart cruise control, collision avoidance, routing, etc.), and/or the like. However, in wireless sensing (e.g., mono-static or bi-static), a UE can detect a large number of multipaths from a given sensing channel. For example, reflection from intended/target object(s), such as a large object, may have different reflection points and thus generate multiple clustered paths. As another example, reflection from unintended/non-target object(s) (e.g., clutter associated with reflections from non-target objects) may be unwanted reflections, such as reflections from ground and buildings, and may even be stronger than the desired reflection from the intended/target object(s). Unintended/non-target object(s) may be differentiated from the intended/target object(s) in material, size, volume, RCS, relative position to UE (e.g., AoA/expected delay), movement/speed (e.g., Doppler/micro-Doppler), etc. As yet another example, the reflection from surroundings may be inevitably affecting sensing functions. That is, if it is desired to detect a specific object (e.g., an intended/target object), reflection from other surroundings may be interference for sensing functions and may be skipped or left out of processing/reporting for sensing operations/functions. Other sensing related functions, e.g., RF fingerprint based positioning or simultaneous localization and mapping (SLAM), may rely on the reflection(s) from surroundings to work.

As noted, aspects herein may relate to network assisted clutter identification, e.g., in RF sensing. In one example, a UE may obtain environmental information associated with a sensing environment and may also detect, during a sensing operation, a set of objects in the sensing environment. The UE may further process data for at least one target object in the set of objects and/or or filter data for at least one unintended object in the set of objects based on the environmental information, where the environmental information indicates at least one characteristic associated with the set of objects in the sensing environment. In an additional example, a network node (e.g., a base station, a portion thereof, and/or the like) may provide, for a UE, environmental information associated with a sensing environment, where the environmental information indicates at least one characteristic associated with a set of objects in the sensing environment, and where the set of objects in the sensing environment includes at least one target object and at least one unintended object. The network node may also receive, from the UE, a sensing indication that corresponds to a sensing operation, where the sensing indication includes sensing information associated with the at least one target object of the set of objects in the sensing environment based on the at least one target object. In aspects herein, environmental information may include previous sensing results (e.g., previously detected objects and/or sensing taking place in a similar position), a priori information (e.g., the size/material RCS); shape/speed/Doppler signature of a specific object; floor map), sensors connected to the network (e.g., a camera/RADAR/light detection and ranging (LIDAR); a weather sensor(s)), and/or the like.

Various aspects herein, such as for network assisted clutter identification, e.g., in RF sensing, may provide for increased sensing accuracy, reductions in power usage, and reductions in processing cycles by utilizing pre-knowledge associated with the environment (e.g., environmental information) of a UE from the network to improve detection and locking of target objects for sensing, while filtering out other reflections of unintended/non-target objects, by a UE running a sensing engine (e.g., for monostatic sensing). Various aspects herein, such as for network assisted clutter identification, e.g., in RF sensing, may provide for reductions in the resources used for reporting by filtering out reflections of unintended/non-target objects by a UE to reduce the number of paths to be reported for the network running a sensing engine (e.g., for bistatic sensing with the UE as the Rx).

In RF sensing (e.g., monostatic or bistatic), a UE can detect a large number of multipaths from the channel. This includes reflection from intended objects, reflections from unintended objects, and reflection(s) from environment. In one aspect, we propose the network provide any pre-knowledge about the environment (e.g., environmental information) to help the UE improve sensing. For example, pre-knowledge may include known locations of intended/unintended objects, object shapes, object materials, and expected path power, etc.

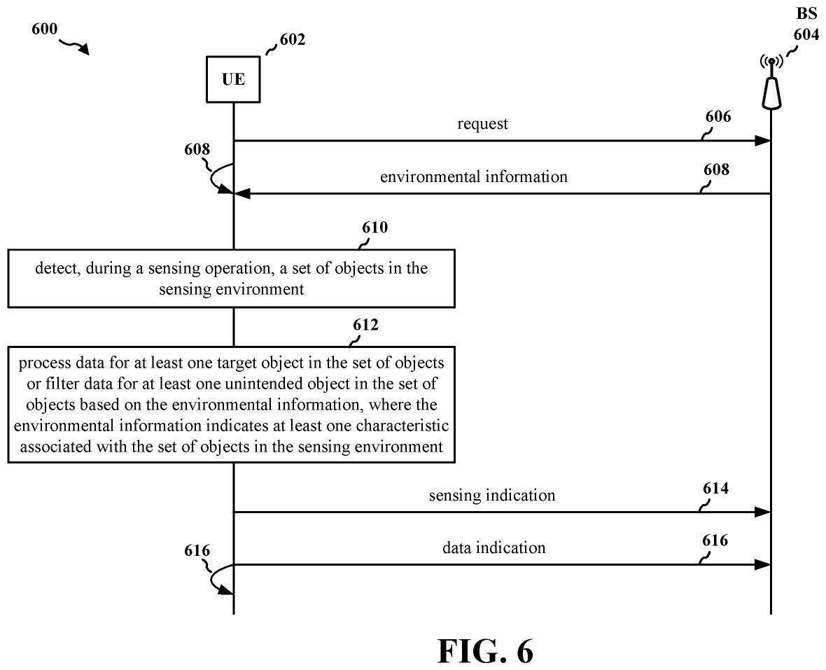

FIG. 6 is a call flow diagram 600 for wireless communications, in accordance with various aspects of the present disclosure. Call flow diagram 600 illustrates network assisted clutter identification, e.g., in RF sensing, by a UE (e.g., a UE 602) that may communicate with a network node (a base station 604, such as a gNB or other type of base station, by way of example, as shown). Aspects described for the base station 604 may be performed by the base station in aggregated form and/or by one or more components of the base station 604 in disaggregated form. Additionally, or alternatively, the aspects may be performed by the UE 602 autonomously, in addition to, and/or in lieu of, operations of the base station 604.

The UE 602 may provide/transmit, to the base station 604, a request 606. The request 606 may be for environmental information 608, and may be provided/transmitted via at least one of first RRC signaling (e.g., UE assistance information, an LTE positioning protocol (LPP) message, etc.), a first MAC-CE, or UCI (e.g., PUCCH) or PRACH (e.g., an on-demand system information (SI) request). In aspects, the request 606 for the environmental information 608 may include position information associated with the UE 602. In aspects, the request 606 for the environmental information 608 may include clutter information associated with the at least one unintended object in the set of objects. In some aspects, providing/transmitting the request 606 may be optional, e.g., where the environmental information 608 is provided by the base station 604 without the request 606, where the UE 602 obtains the environmental information 608 in another manner.

The UE 602 may obtain/receive the environmental information 608 associated with a sensing environment of the UE 602. The environmental information 608 may be associated with at least one of a previous sensing operation result, a priori information for the at least one unintended object, or a sensor associated with the network node (e.g., the base station 604, another network entity, or a sensor otherwise connected to the network). In aspects, the base station 604 may provide/transmit the environmental information 608 for the UE 602. The base station 604 may provide/transmit the environmental information 608 for the UE 602 via at least one of second RRC signaling, a second MAC-CE, or DCI provided for the UE, or via system information in a broadcast signal. The base station 604 may provide/transmit the environmental information 608 for the UE 602 based on the request 606, described above, e.g., the environmental information 608 may be tailored to the position of the UE 602 in the request 606. In some aspects, the UE 602 may obtain/receive the environmental information 608 by performing a channel estimation based on at least one sensing signal. In aspects, the environmental information 608 may be based at least in part on the position information associated with the UE 602.

The UE 602 may detect (at 610), during a sensing operation, a set of objects in the sensing environment. In aspects, the sensing operation may be a monostatic sensing operation (e.g., at/by the UE 602) or a bistatic sensing operation (e.g., at/by the UE 602 with the base station 604). The set of objects may include at least one target object for sensing by the UE and may include at least one unintended object (e.g., a non-target object, reflections of which may cause clutter in the sensing session). Additionally, e.g., as a portion of the sensing operation in which the UE 602 detects (at 610) the set of objects, the UE may sense the at least one target object during the sensing operation (e.g., at 610) in the sensing environment.

The UE 602 may process (at 612) data for at least one target object in the set of objects or filter (at 612) data for at least one unintended object in the set of objects based on the environmental information 608. The environmental information 608 may indicate at least one characteristic associated with the set of objects in the sensing environment. In aspects, the at least one characteristic associated with the set of objects may include at least one of a location, a shape, a material, material information, or an expected signaling path power of at least one signaling path of one or more objects of the set of objects. When the UE 602 processes (at 612) the at least one target object based on the sensing operation, the UE 602 may observe, calculate, and/or generate data and/or information for a sensing indication 614 that includes sensing information associated with the at least one target object based on the processed (e.g., at 612) at least one target object. In aspects, the UE 602 may exclude data (e.g., from the processing at 612) for the at least one unintended object in the set of objects based on the environmental information 608 via a filter operation (at 612). The data for the at least one unintended object in the set of objects may be at least one of a time of arrival (ToA), an AoA, a velocity, a Doppler shift, a micro-Doppler shift, a signaling path power, and/or the like.

The UE 602 may provide/transmit, for a network node (e.g., the base station 604), the sensing indication 614. The sensing indication 614 may include sensing information associated with the at least one target object based on the processed (at 612) at least one target object. In aspects, the sensing indication 614 may be based on a sensing configuration (e.g., provided for the UE 602 from the base station 604). The sensing indication 614 may further include at least one of a signaling path that (1) is within a delay range, (2) is within the delay range or an AoA range, (3) has a Doppler shift, (4) has a signaling path power that meets a power threshold, or (5) has a reflector unidentified in the environmental information.

The UE 602 may output a data indication 616 of the processed data for the at least one target object or the filtered data for the at least one unintended object. To output the data indication 616, the UE may be configured to store (e.g., in a memory of the UE 602) the data indication 616 of the processed data for the at least one target object or the filtered data for the at least one unintended object, and/or may be configured to transmit/provide the data indication 616 of the processed data for the at least one target object or the filtered data for the at least one unintended object (e.g., to the base station 604, which may be configured to receive the data indication 616).

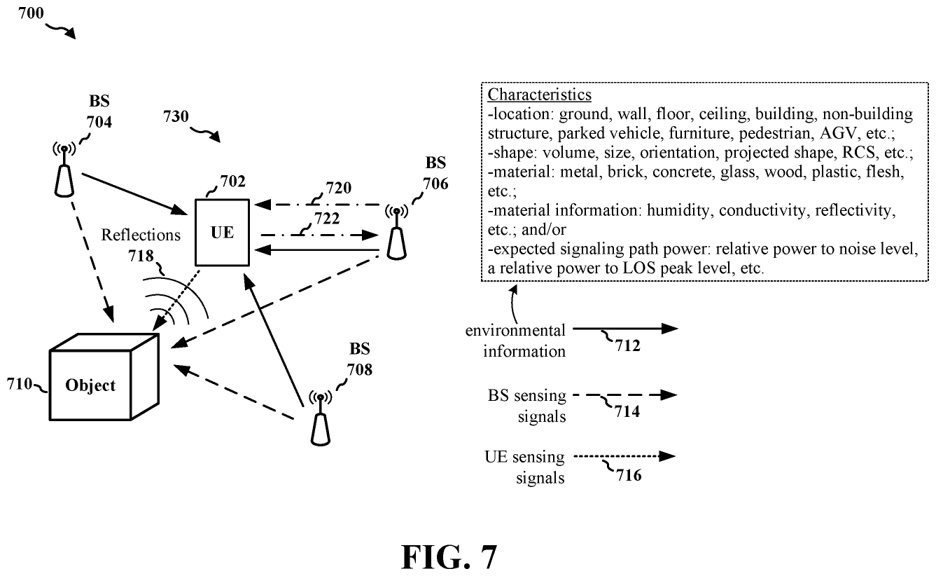

FIG. 7 is a diagram 700 illustrating an example of network assisted clutter identification in RF sensing, in accordance with various aspects of the present disclosure. In aspects, diagram 700 illustrates a simplified sensing environment in which a UE 702 may communicate with one or more base stations, e.g., a base station 704, a base station 706, and a base station 708. An object 710 may be sensed during a sensing session/operation to determine its sensing characteristics: e.g., location, heading, velocity, a physiological characteristic thereof, gestures, and/or the like. In aspects, the object 710 may be a target object or an unintended/non-target object.

One or more of the base station 704, the base station 706, and/or the base station 708 may transmit/provide environmental information 712 for the UE 702 which may receive the environmental information 712. The environmental information 712 may include one or more sensing characteristics associated with the object 710, e.g., in the sensing environment, which may be one object of a set of objects. The characteristics may include a location, a shape, a material, material information, an expected signaling path power of at least one signaling path of one or more objects of a set of objects, and/or the like.

The location of one or more objects, e.g., fixed or stationary objects that may not change position during a certain time and thus can be obtained in advance, may include at least one of ground, a wall, a floor, a ceiling, a building, floorplan, a map, a non-building structure, a parked vehicle, furniture, etc., while mobile objects may include a pedestrian, an automated guided vehicle (AGV), a drone, etc., and/or the like. Mobile objects, e.g., a pedestrian, an AGV, a drone, etc., may be indicated with respective positions in most recent measurements, and with speeds and/or micro-Doppler signatures, in aspects. Based on the position of UE 702, the corresponding AoA/exceeding delay (e.g., relative LOS path) or range maybe calculated by network side (e.g., one of the base station 704, the base station 706, and/or the base station 708) and indicated to the UE 702.

The shape of one or more objects may include at least one of a volume, a size, an orientation, a projected shape, a RCS, and/or the like. The projected shape may also affect the delay spread of the cluster corresponding to the object 710. The RCS of the object 710 may also affect the reflection strength of the object 710. In aspects, the threshold of path detection (e.g., a constant false alarm rate (CFAR)) may be adjusted accordingly to detect the intended path of the object 710 and filter out the path(s) with lower power.

The material of one or more objects may include at least one of metal, brick, concrete, glass, wood, plastic, flesh, and/or the like. The material information of one or more objects may include at least one of humidity, conductivity, reflectivity, and/or the like.

The expected signaling path power of one or more objects may include at least one of a relative power to noise level, a relative power to line of sight (LOS) peak level, and/or the like. Some path detection algorithms (e.g., CFAR) may discard weak paths below a given threshold.

In some aspects, one or more of the base station 704, the base station 706, and/or the base station 708 may transmit sensing signals 714, e.g., for bistatic sensing operations, which may be reflected by the object 710 as reflections 718. The UE 702 may receive/obtain the reflections 718 to determine one or more of the sensing characteristics for the object 710. In some aspects, the UE 702 may transmit sensing signals 716, e.g., for monostatic sensing operations, which may be reflected by the object 710 as reflections 718. The UE 702 may receive/obtain the reflections 718 to determine one or more of the sensing characteristics for the object 710. For aspects where the object 710 is a target object, the UE 702 may utilize the environmental information 712 to process data for the object 710. In contrast, for aspects where the object 710 is a not a target object, e.g., is an unintended object, the UE 702 may utilize the environmental information 712 to filter data for the object 710.

In some aspects, a network node (e.g., the base station 706, as shown by way of example) may transmit/provide for the UE 702 a configuration 720 that includes an indication of a reporting strategy for the UE 702 based on one or more parameters for cluster identification. The configuration 720 may indicate that the UE 702 report any paths within a certain delay/AoA range, or with a Doppler shift (e.g., for a moving object), path power below/above/meeting a threshold, etc. In some aspects, the UE 702 may also provide a report 722 of at least one/any path which for which the UE 702 is unable to find a corresponding reflector in the indicated surrounding information (e.g., the environmental information 712) as an anomaly detection. Such a report may include the delay, AoA, Doppler shift, path power of the unidentified path(s), and/or the like. Upon receiving this reported information from the UE 702, the network (e.g., the base station 706, as shown by way of example) may prepare for sensing to find out the exact reflector of the unidentified path(s) and/or store/update the reported information for a future clutter identification enquiry.

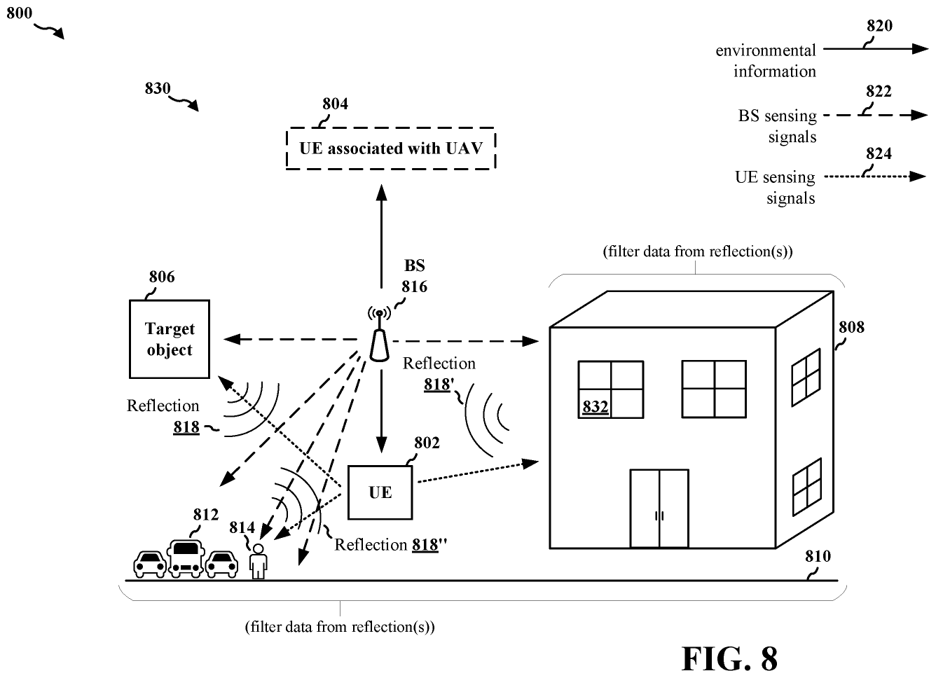

FIG. 8 is a diagram 800 illustrating an example of network assisted clutter identification in RF sensing, in accordance with various aspects of the present disclosure. In the illustrated aspect, the diagram 800 shows a sensing environment 830 in which a UE 802 (and/or a UE 804 associated with an unmanned aerial vehicle (UAV)) and/or a base station 816 perform network assisted clutter identification via RF sensing of a target object 806. That is, the UE 802 may utilize environmental information 820 from the base station 816 for improved sensing of target objects (e.g., via monostatic/bistatic sensing modes) within the sensing environment 830 in which the UE 802 may be located, as described herein.

In aspects, a sensing environment may be an environment in which a sensing node (e.g., the UE 802 and/or the base station 816) resides and that may be sensed by the sensing node through a sensing mode thereof. The sensing environment 830 may represent a rich scattering/cluttering environment and may include unintended/non-target objects such as, but without limitation, a building 808 or equivalent structures (e.g., including exterior structure for outdoor environments, interior spaces for indoor environments (e.g., an indoor sensing environment 832), etc.), surface features or ground 810 (e.g., pavement such as streets, sidewalks, bridges, signs/billboards, and/or other non-building infrastructure, trees, terrain, etc.), vehicles 812, persons 814, and/or the like. In aspects, a target object(s) and an unintended object(s) may be at least a portion of a set of objects that may be detected by the UE 802 during a sensing session.

A receiver (Rx) of the UE 802 may receive/detect clutter (or echo) during sensing operations due to the signal from the associated transmitter (Tx) (e.g., base station sensing signals 822 and/or UE sensing signals 824) being reflected by portions of the sensing environment 830, e.g., unintended objects. For example, a transmitted sensing signal/waveform may be reflected from the building 808 as a reflection 818′, while a transmitted sensing signal/waveform may be reflected from one or more of the surface features 810, the vehicles 812, the persons 814, and/or the like, as a reflection 818″, and clutter from signal reflections such as the reflection 818′ and/or the reflection 818″ may impair, or interfere with, signals in sensing and communications to different degrees based on the characteristics (e.g., RCS, reflectivity, and/or the like, as described herein) of the unintended/non-target objects in the sensing environment 830. As one example, the façade of the building 808 may include some materials such as concrete, brick, wood, etc., that reflect transmitted signals/waveforms for sensing, as well as other materials such as types of glass, metals, etc., that may reflect higher levels of transmitted signals/waveforms for sensing. Similarly, the target object may reflect a reflection 818 based on the base station sensing signals 822 and/or the UE transmits the UE sensing signals 824.

In aspects, the environmental information 820 associated with the sensing environment 830, and the objects therein, may be provided/transmitted for the UE 802 by the base station 816, and may be received by the UE 802 as network-assisted/aided clutter identification information. When the base station 816 transmits the base station sensing signals 822 and/or when the UE transmits the UE sensing signals 824 for sensing of the target object 806, the reflection 818, the reflection 818′, and/or the reflection 818″ may be received by the UE 802. The UE 802 may utilize the environmental information 820 to process data for the target object 806 (e.g., of the set of objects that includes the unintended objects) based on the reflection 818, and/or to filter data for at least one unintended object (e.g., in the set of objects: the building 808 and the reflection 818′, the surface features 810, the vehicles 812, the persons 814, and/or the like, and the reflection 818″), based on the reflection 818′ and/or the reflection 818″.

For instance, the UE 802 may associate detected paths in monostatic/bistatic sensing with indicated surroundings based on the environmental information 820 for the sensing environment 830. The association may be determined based on a delay (or a relative delay to LOS path), an AOA, a reflection strength, etc. In aspects, UE 802 pose information, e.g., UE position, antenna orientation, etc., and beam information, e.g., TRP and UE beam direction, shape, etc., may also be accounted for the association. With the association, the UE 802 may identify if a detected path in the sensing is from known surroundings or not. The association may also be applied to improve positioning accuracy, maximum permissible exposure (MPE) detection, and/or the like.

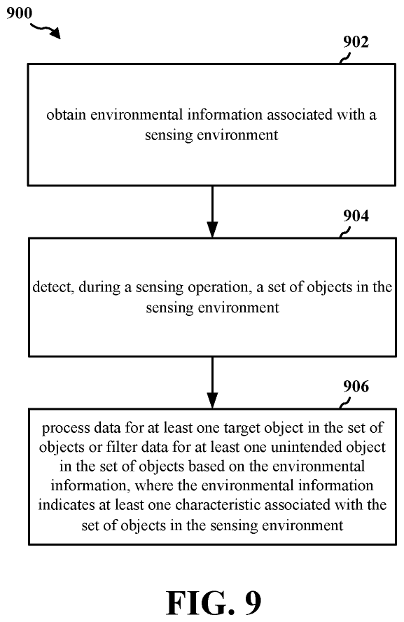

FIG. 9 is a flowchart 900 of a method of wireless communication, in accordance with various aspects of the present disclosure. The method may be performed by a UE (e.g., the UE 104, 602, 702, 802, 804; the apparatus 1104). In some aspects, the method may include aspects described in connection with the communication flow in FIG. 6 and/or aspects described in FIGS. 7, 8. The method provides for network assisted clutter identification, e.g., in RF sensing, that enables provision of environmental data associated with a UE (e.g., that is running a sensing engine) to improve detection and locking of target objects for sensing by which increased sensing accuracy, reductions in power usage, and reductions in processing cycles are realized, and that enables filtering of reflections of unintended/non-target objects by a UE to reduce the number of paths to be reported for the network (e.g., that is running a sensing engine), which reduces the resources used for reporting to the network.

At 902, a UE obtains environmental information associated with a sensing environment. As an example, the obtaining may be performed, at least in part, by the component 198. FIGS. 6-8 illustrate an example of a UE (e.g., the UE 602) obtaining such environmental information from a network node (e.g., the base station 604).

The UE 602 may provide/transmit, to the base station 604, a request 606. The request 606 may be for environmental information 608 (e.g., 712 in FIG. 7; 820 in FIG. 8), and may be provided/transmitted via at least one of first RRC signaling, a first MAC-CE, or UCI. In aspects, the request 606 for the environmental information 608 (e.g., 712 in FIG. 7; 820 in FIG. 8) may include position information associated with the UE. In aspects, the request 606 for the environmental information 608 (e.g., 712 in FIG. 7; 820 in FIG. 8) may include clutter information associated with the at least one unintended object (e.g., 710 in FIG. 7; 808, 810, 812, 814 in FIG. 8) in the set of objects. In some aspects, providing/transmitting the request 606 may be optional, e.g., where the environmental information 608 is provided by the base station 604 without the request 606, where the UE 602 obtains the environmental information 608 (e.g., 712 in FIG. 7; 820 in FIG. 8) in another manner. The UE 602 may obtain/receive the environmental information 608 (e.g., 712 in FIG. 7; 820 in FIG. 8) associated with a sensing environment (e.g., 730 in FIG. 7; 830 in FIG. 8) of the UE 602. The environmental information 608 (e.g., 712 in FIG. 7; 820 in FIG. 8) may be associated with at least one of a previous sensing operation result, a priori information for the at least one unintended object (e.g., 710 in FIG. 7; 808, 810, 812, 814 in FIG. 8), or a sensor associated with the network node (e.g., the base station 604, another network entity, or a sensor otherwise connected to the network). In aspects, the base station 604 may provide/transmit the environmental information 608 (e.g., 712 in FIG. 7; 820 in FIG. 8) for the UE 602. The base station 604 may provide/transmit the environmental information 608 (e.g., 712 in FIG. 7; 820 in FIG. 8) for the UE 602 via at least one of second RRC signaling, a second MAC-CE, or DCI provided for the UE, or via system information in a broadcast signal. The base station 604 may provide/transmit the environmental information 608 (e.g., 712 in FIG. 7; 820 in FIG. 8) for the UE 602 based on the request 606, described above. In some aspects, the UE 602 may obtain/receive the environmental information 608 by performing a channel estimation based on at least one sensing signal (e.g., e.g., 714, 716, 718 in FIG. 7; 818, 818′, 818″, 822, 824 in FIG. 8). In aspects, the environmental information 608 (e.g., 712 in FIG. 7; 820 in FIG. 8) may be based at least in part on the position information associated with the UE 602.

At 904, the UE detects, during a sensing operation, a set of objects in the sensing environment. As an example, the detection may be performed, at least in part, by the component 198. FIGS. 6-8 illustrate an example of a UE (e.g., the UE 602) detecting such a set of objects in sensing environment.

The UE 602 may detect (at 610), during a sensing operation (e.g., e.g., 714, 716, 718 in FIG. 7; 818, 818′, 818″, 822, 824 in FIG. 8), a set of objects in the sensing environment (e.g., 730 in FIG. 7; 830 in FIG. 8). In aspects, the sensing operation (e.g., e.g., 714, 716, 718 in FIG. 7; 818, 818′, 818″, 822, 824 in FIG. 8) may be a monostatic sensing operation (e.g., at/by the UE 602) or a bistatic sensing operation (e.g., at/by the UE 602 with the base station 604). The set of objects may include at least one target object (e.g., 710 in FIG. 7; 806 in FIG. 8) for sensing (e.g., e.g., 714, 716, 718 in FIG. 7; 818, 818′, 818″, 822, 824 in FIG. 8) by the UE and may include at least one unintended object (e.g., a non-target object, reflections of which may cause clutter in the sensing session) (e.g., 710 in FIG. 7; 808, 810, 812, 814 in FIG. 8). Additionally, e.g., as a portion of the sensing operation (e.g., e.g., 714, 716, 718 in FIG. 7; 818, 818′, 818″, 822, 824 in FIG. 8) in which the UE 602 detects (at 610) the set of objects, the UE may sense (e.g., e.g., 714, 716, 718 in FIG. 7; 818, 818′, 818″, 822, 824 in FIG. 8) the at least one target object (e.g., 710 in FIG. 7; 806 in FIG. 8) during the sensing operation (e.g., at 610) (e.g., e.g., 714, 716, 718 in FIG. 7; 818, 818′, 818″, 822, 824 in FIG. 8) in the sensing environment (e.g., 730 in FIG. 7; 830 in FIG. 8).

At 906, the UE processes data for at least one target object in the set of objects or filters data for at least one unintended object in the set of objects based on the environmental information, where the environmental information indicates at least one characteristic associated with the set of objects in the sensing environment. As an example, the processing and/or filtering may be performed, at least in part, by the component 198. FIGS. 6-8 illustrate an example of a UE (e.g., the UE 602) processing and/or filtering such types of data.

The UE 602 may process (at 612) data for at least one target object (e.g., 710 in FIG. 7; 806 in FIG. 8) in the set of objects or filter (at 612) data for at least one unintended object (e.g., 710 in FIG. 7; 808, 810, 812, 814 in FIG. 8) in the set of objects based on the environmental information 608 (e.g., 712 in FIG. 7; 820 in FIG. 8). The environmental information 608 (e.g., 712 in FIG. 7; 820 in FIG. 8) may indicate at least one characteristic associated with the set of objects in the sensing environment (e.g., 730 in FIG. 7; 830 in FIG. 8). In aspects, the at least one characteristic associated with the set of objects may include at least one of a location, a shape, a material, material information, or an expected signaling path power of at least one signaling path of one or more objects of the set of objects. When the UE 602 processes (at 612) the at least one target object (e.g., 710 in FIG. 7; 806 in FIG. 8) based on the sensing operation (e.g., e.g., 714, 716, 718 in FIG. 7; 818, 818′, 818″, 822, 824 in FIG. 8), the UE 602 may observe, calculate, and/or generate data and/or information for a sensing indication 614 that includes sensing information associated with the at least one target object (e.g., 710 in FIG. 7; 806 in FIG. 8) based on the processed (e.g., at 612) at least one target object (e.g., 710 in FIG. 7; 806 in FIG. 8). In aspects, the UE 602 may exclude data (e.g., from the processing at 612) for the at least one unintended object (e.g., 710 in FIG. 7; 808, 810, 812, 814 in FIG. 8) in the set of objects based on the environmental information 608 (e.g., 712 in FIG. 7; 820 in FIG. 8) via a filter operation (at 612). The data for the at least one unintended object (e.g., 710 in FIG. 7; 808, 810, 812, 814 in FIG. 8) in the set of objects may be at least one of a ToA, an AoA, a velocity, a Doppler shift, a micro-Doppler shift, a signaling path power, and/or the like. The UE 602 may provide/transmit, for a network node (e.g., the base station 604), the sensing indication 614. The sensing indication 614 may include sensing information associated with the at least one target object (e.g., 710 in FIG. 7; 806 in FIG. 8) based on the processed (at 612) at least one target object (e.g., 710 in FIG. 7; 806 in FIG. 8). In aspects, the sensing indication 614 may be based on a sensing configuration (e.g., provided for the UE 602 from the base station 604). The sensing indication 614 may further include at least one of a signaling path that (1) is within a delay range, (2) is within the delay range or an AoA range, (3) has a Doppler shift. (4) has a signaling path power that meets a power threshold, or (5) has a reflector unidentified in the environmental information 608 (e.g., 712 in FIG. 7; 820 in FIG. 8).

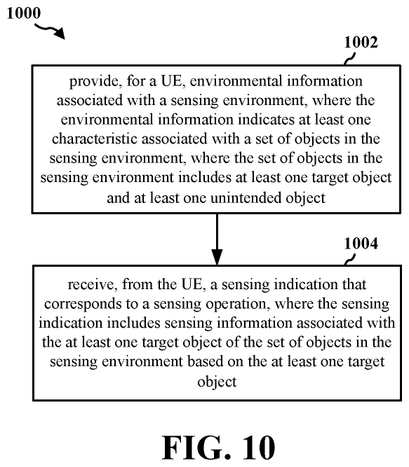

FIG. 10 is a flowchart 1000 of a method of wireless communication, in accordance with various aspects of the present disclosure. The method may be performed by a base station (e.g., the base station 102, 604, 704, 706, 708, 816; the network entity 1102, 1202). In some aspects, the method may include aspects described in connection with the communication flow in FIG. 6 and/or aspects described in FIGS. 7, 8. The method provides for network assisted clutter identification, e.g., in RF sensing, that enables provision of environmental data associated with a UE (e.g., that is running a sensing engine) to improve detection and locking of target objects for sensing by which increased sensing accuracy, reductions in power usage, and reductions in processing cycles are realized, and that enables filtering of reflections of unintended/non-target objects by a UE to reduce the number of paths to be reported for the network (e.g., that is running a sensing engine), which reduces the resources used for reporting to the network.

At 1002, a network node provides, for a UE, environmental information associated with a sensing environment, where the environmental information indicates at least one characteristic associated with a set of objects in the sensing environment, where the set of objects in the sensing environment includes at least one target object and at least one unintended object. As an example, the provision may be performed, at least in part, by the component 199. FIGS. 6-8 illustrate an example of a network node (e.g., the base station 604) providing/transmitting such environmental information for a UE (e.g., the UE 602).

As noted above, the UE 602 may provide/transmit, to the base station 604, a request 606. The request 606 may be for environmental information 608 (e.g., 712 in FIG. 7; 820 in FIG. 8), and may be provided/transmitted via at least one of first RRC signaling, a first MAC-CE, or UCI, and received by the base station 604. In aspects, the request 606 for the environmental information 608 may include position information associated with the UE 602. In aspects, the request 606 for the environmental information 608 (e.g., 712 in FIG. 7; 820 in FIG. 8) may include clutter information associated with the at least one unintended object (e.g., 710 in FIG. 7; 808, 810, 812, 814 in FIG. 8) in the set of objects.

The base station 604 may provide/transmit the environmental information 608 (e.g., 712 in FIG. 7; 820 in FIG. 8) for the UE 602. The base station 604 may provide/transmit the environmental information 608 (e.g., 712 in FIG. 7; 820 in FIG. 8) for the UE 602 via at least one of second RRC signaling, a second MAC-CE, or DCI provided for the UE, or via system information in a broadcast signal. The base station 604 may provide/transmit the environmental information 608 (e.g., 712 in FIG. 7; 820 in FIG. 8) for the UE 602 based on the request 606, described above. The UE 602 may thus obtain/receive the environmental information 608 (e.g., 712 in FIG. 7; 820 in FIG. 8) associated with a sensing environment (e.g., 730 in FIG. 7; 830 in FIG. 8) of the UE 602. The environmental information 608 (e.g., 712 in FIG. 7; 820 in FIG. 8) may be associated with at least one of a previous sensing operation (e.g., e.g., 714, 716, 718 in FIG. 7; 818, 818′, 818″, 822, 824 in FIG. 8) result, a priori information for the at least one unintended object (e.g., 710 in FIG. 7; 808, 810, 812, 814 in FIG. 8), or a sensor associated with the network node (e.g., the base station 604, another network entity, or a sensor otherwise connected to the network). In some aspects, the UE 602 may obtain/receive the environmental information 608 (e.g., 712 in FIG. 7; 820 in FIG. 8) by performing a channel estimation based on at least one sensing signal (e.g., e.g., 714, 716, 718 in FIG. 7; 818, 818′, 818″, 822, 824 in FIG. 8). In aspects, the environmental information 608 (e.g., 712 in FIG. 7; 820 in FIG. 8) may be based at least in part on the position information associated with the UE 602.

At 1004, the network node receives, from the UE, a sensing indication that corresponds to a sensing operation, where the sensing indication includes sensing information associated with the at least one target object of the set of objects in the sensing environment based on the at least one target object. As an example, the reception may be performed, at least in part, by the component 199. FIGS. 6-8 illustrate an example of a network node (e.g., the base station 604) receiving such a sensing indication from a UE (e.g., the UE 602).

The base station 604 may receive, from the UE 602, the sensing indication 614. The sensing indication 614 may include sensing information associated with the at least one target object (e.g., 710 in FIG. 7; 806 in FIG. 8) based on the processed (at 612) at least one target object (e.g., 710 in FIG. 7; 806 in FIG. 8). In aspects, the sensing indication 614 may be based on a sensing configuration (e.g., provided for the UE 602 from the base station 604). The sensing indication 614 may further include at least one of a signaling path that (1) is within a delay range, (2) is within the delay range or an AoA range, (3) has a Doppler shift. (4) has a signaling path power that meets a power threshold, or (5) has a reflector unidentified in the environmental information 608 (e.g., 712 in FIG. 7; 820 in FIG. 8).

For instance, as noted above, the UE 602 may detect (at 610), during a sensing operation (e.g., e.g., 714, 716, 718 in FIG. 7; 818, 818′, 818″, 822, 824 in FIG. 8), a set of objects in the sensing environment (e.g., 730 in FIG. 7; 830 in FIG. 8). In aspects, the sensing operation (e.g., e.g., 714, 716, 718 in FIG. 7; 818, 818′, 818″, 822, 824 in FIG. 8) may be a monostatic sensing operation (e.g., at/by the UE 602) or a bistatic sensing operation (e.g., at/by the UE 602 with the base station 604). The set of objects may include at least one target object (e.g., 710 in FIG. 7; 806 in FIG. 8) for sensing (e.g., e.g., 714, 716, 718 in FIG. 7; 818, 818′, 818″, 822, 824 in FIG. 8) by the UE and may include at least one unintended object (e.g., a non-target object, reflections of which may cause clutter in the sensing session) (e.g., 710 in FIG. 7; 808, 810, 812, 814 in FIG. 8). Additionally, e.g., as a portion of the sensing operation (e.g., e.g., 714, 716, 718 in FIG. 7; 818, 818′, 818″, 822, 824 in FIG. 8) in which the UE 602 detects (at 610) the set of objects, the UE may sense (e.g., e.g., 714, 716, 718 in FIG. 7; 818, 818′, 818″, 822, 824 in FIG. 8) the at least one target object (e.g., 710 in FIG. 7; 806 in FIG. 8) during the sensing operation (e.g., at 610) in the sensing environment (e.g., 730 in FIG. 7; 830 in FIG. 8). The UE 602 may process (at 612) data for at least one target object (e.g., 710 in FIG. 7; 806 in FIG. 8) in the set of objects or filter (at 612) data for at least one unintended object (e.g., 710 in FIG. 7; 808, 810, 812, 814 in FIG. 8) in the set of objects based on the environmental information 608 (e.g., 712 in FIG. 7; 820 in FIG. 8). The environmental information 608 (e.g., 712 in FIG. 7; 820 in FIG. 8) may indicate at least one characteristic associated with the set of objects in the sensing environment (e.g., 730 in FIG. 7; 830 in FIG. 8). In aspects, the at least one characteristic associated with the set of objects may include at least one of a location, a shape, a material, material information, or an expected signaling path power of at least one signaling path of one or more objects of the set of objects. When the UE 602 processes (at 612) the at least one target object (e.g., 710 in FIG. 7; 806 in FIG. 8) based on the sensing operation (e.g., e.g., 714, 716, 718 in FIG. 7; 818, 818′, 818″, 822, 824 in FIG. 8), the UE 602 may observe, calculate, and/or generate data and/or information for a sensing indication 614 that includes sensing information associated with the at least one target object (e.g., 710 in FIG. 7; 806 in FIG. 8) based on the processed (e.g., at 612) at least one target object (e.g., 710 in FIG. 7; 806 in FIG. 8). In aspects, the UE 602 may exclude data (e.g., from the processing at 612) for the at least one unintended object (e.g., 710 in FIG. 7; 808, 810, 812, 814 in FIG. 8) in the set of objects based on the environmental information 608 (e.g., 712 in FIG. 7; 820 in FIG. 8) via a filter operation (at 612). The data for the at least one unintended object (e.g., 710 in FIG. 7; 808, 810, 812, 814 in FIG. 8) in the set of objects may be at least one of a ToA, an AoA, a velocity, a Doppler shift, a micro-Doppler shift, a signaling path power, and/or the like.

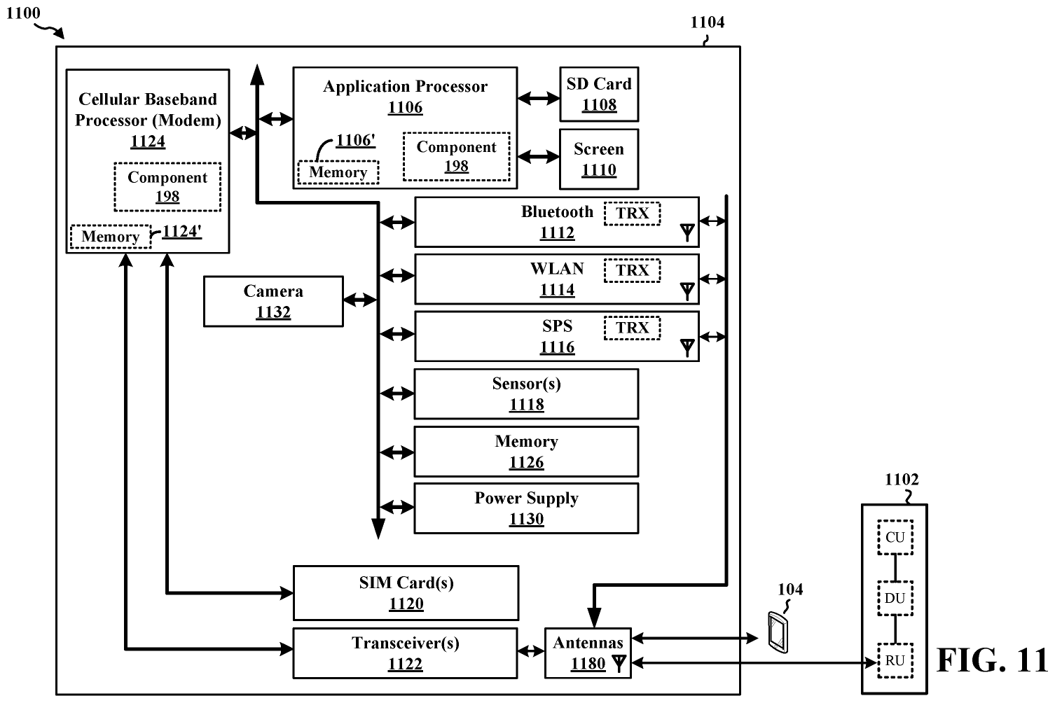

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 may be configured to obtain environmental information associated with a sensing environment. The component 198 may also be configured to detect, during a sensing operation, a set of objects in the sensing environment. The component 198 may be further configured to process data for at least one target object in the set of objects or filter data for at least one unintended object in the set of objects based on the environmental information, where the environmental information indicates at least one characteristic associated with the set of objects in the sensing environment. The component 198 may also be configured to provide, for a network node, a request for the environmental information via at least one of first RRC signaling, a first MAC-CE, or UCI. The component 198 may also be configured to sense the at least one target object during the sensing operation in the sensing environment. The component 198 may also be configured to process the at least one target object based on the sensing operation. The component 198 may also be configured to provide, for a network node, a sensing indication that includes sensing information associated with the at least one target object based on the processed at least one target object. The component 198 may also be configured to output an indication of the processed data for the at least one target object or the filtered data for the at least one unintended object. The component 198 may be further configured to perform any of the aspects described in connection with the flowcharts in any of FIGS. 9, 10, and/or any of the aspects performed by a UE for any of FIGS. 6-8. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, may include means for obtaining environmental information associated with a sensing environment. In the configuration, the apparatus 1104, and in particular the cellular baseband processor 1124 and/or the application processor 1106, may include means for detecting, during a sensing operation, a set of objects in the sensing environment. In the configuration, the apparatus 1104, and in particular the cellular baseband processor 1124 and/or the application processor 1106, may include means for processing data for at least one target object in the set of objects or means for filtering data for at least one unintended object in the set of objects based on the environmental information, where the environmental information indicates at least one characteristic associated with the set of objects in the sensing environment. In one configuration, the apparatus 1104, and in particular the cellular baseband processor 1124 and/or the application processor 1106, may include means for providing, for a network node, a request for the environmental information via at least one of first RRC signaling, a first MAC-CE, or DCI. In one configuration, the apparatus 1104, and in particular the cellular baseband processor 1124 and/or the application processor 1106, may include means for sensing the at least one target object during the sensing operation in the sensing environment. In one configuration, the apparatus 1104, and in particular the cellular baseband processor 1124 and/or the application processor 1106, may include means for processing the at least one target object based on the sensing operation. In one configuration, the apparatus 1104, and in particular the cellular baseband processor 1124 and/or the application processor 1106, may include means for providing, for a network node, a sensing indication that includes sensing information associated with the at least one target object based on the processed at least one target object. In one configuration, the apparatus 1104, and in particular the cellular baseband processor 1124 and/or the application processor 1106, may include means for outputting an indication of the processed data for the at least one target object or the filtered data for the at least one unintended object. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

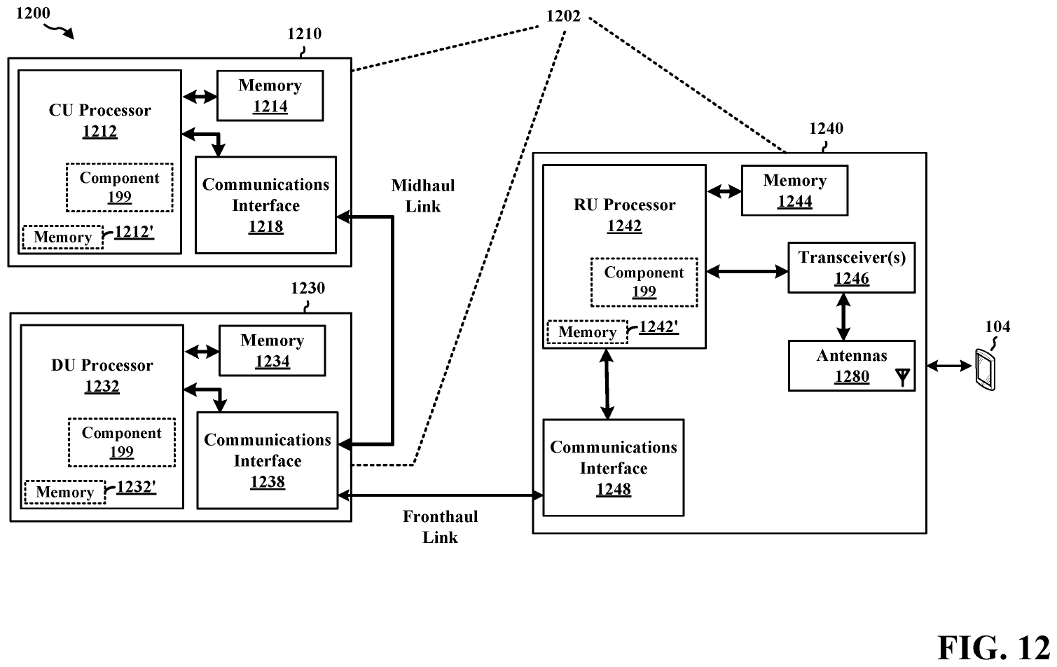

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, for a UE, environmental information associated with a sensing environment, where the environmental information indicates at least one characteristic associated with a set of objects in the sensing environment, where the set of objects in the sensing environment includes at least one target object and at least one unintended object. The component 199 may also be configured to receive, from the UE, a sensing indication that corresponds to a sensing operation, where the sensing indication includes sensing information associated with the at least one target object of the set of objects in the sensing environment based on the at least one target object. The component 199 may be configured to receive, from the UE, a request for the environmental information via at least one of first RRC signaling, a first MAC-CE, or UCI. The component 199 may be configured to receive a data indication of processed data for the at least one target object or filtered data for the at least one unintended object. The component 199 may be further configured to perform any of the aspects described in connection with the flowcharts in any of FIGS. 9, 10, and/or any of the aspects performed by a UE for any of FIGS. 6-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for providing, for a UE, environmental information associated with a sensing environment, where the environmental information indicates at least one characteristic associated with a set of objects in the sensing environment, where the set of objects in the sensing environment includes at least one target object and at least one unintended object. In the configuration, the network entity 1202 may include means for receiving, from the UE, a sensing indication that corresponds to a sensing operation, where the sensing indication includes sensing information associated with the at least one target object of the set of objects in the sensing environment based on the at least one target object. In one configuration, the network entity 1202 may include means for receiving, from the UE, a request for the environmental information via at least one of first RRC signaling, a first MAC-CE, or UCI. In one configuration, the network entity 1202 may include means for receiving a data indication of processed data for the at least one target object or filtered data for the at least one unintended object. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

RF sensing may be utilized to enable location detection of device-free objects. RF sensing may be regarded as consumer-level RADAR with advanced detection capabilities. RF sensing may enable touchless/device-free interaction with a device and/or system, and RF waveforms may be utilized for communications (e.g., 3GPP NR) and for sensing applications. For instance, mmWave RF signals (e.g., 3GPP NR FR2/FR2x/FR4) may be utilized for range (distance) detection. In different applications, RF sensing may be used for health monitoring (e.g., heartbeat detection, respiration rate monitoring, etc.), gesture recognition (e.g., human activity recognition, keystroke detection, sign language recognition, etc.), contextual information acquisition (e.g., location detection/tracking, direction finding, range estimation, etc.), automotive/unmanned aerial vehicle RADAR (e.g., smart cruise control, collision avoidance, routing, etc.), and/or the like. However, in wireless sensing (e.g., mono-static or bi-static), a UE can detect a large number of multipaths from a given sensing channel. For example, reflection from intended/target object(s), such as a large object, may have different reflection points and thus generate multiple clustered paths. As another example, reflection from unintended/non-target object(s) (e.g., clutter associated with reflections from non-target objects) may be unwanted reflections, such as reflections from ground and buildings, and may even be stronger than the desired reflection from the intended/target object(s). Unintended/non-target object(s) may be differentiated from the intended/target object(s) in material, size, volume, RCS, relative position to UE (e.g., an AoA/expected delay), movement/speed (e.g., Doppler/micro-Doppler), etc. As yet another example, the reflection from surroundings may be inevitably affecting sensing functions. That is, if it is desired to detect a specific object (e.g., an intended/target object), reflection from other surroundings may be interference for sensing functions and may be skipped or left out of processing/reporting for sensing operations/functions. Other sensing related functions, e.g., RF fingerprint based positioning or simultaneous localization and mapping (SLAM), may rely on the reflection(s) from surroundings to work.

Various aspects herein, such as for network assisted clutter identification, e.g., in RF sensing, may provide for increased sensing accuracy, reductions in power usage, and reductions in processing cycles by utilizing pre-knowledge associated with the environment of a UE from the network to improve detection and locking of target objects for sensing, while filtering out other reflections of unintended/non-target objects, by a UE running a sensing engine (e.g., for monostatic sensing). Various aspects herein, such as for network assisted clutter identification, e.g., in RF sensing, may provide for reductions in the resources used for reporting by filtering out reflections of unintended/non-target objects by a UE to reduce the number of paths to be reported for the network running a sensing engine (e.g., for bistatic sensing with the UE as the Rx).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when.” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: obtaining environmental information associated with a sensing environment; detecting, during a sensing operation, a set of objects in the sensing environment; and processing data for at least one target object in the set of objects or filtering data for at least one unintended object in the set of objects based on the environmental information, where the environmental information indicates at least one characteristic associated with the set of objects in the sensing environment.

Aspect 2 is the method of aspect 1, wherein the environmental information is associated with at least one of a previous sensing operation result, a priori information for the at least one unintended object, or a sensor of a network node.

Aspect 3 is the method of any of aspects 1 and 2, wherein the at least one characteristic associated with the set of objects includes at least one of a location, a shape, a material, material information, or an expected signaling path power of at least one signaling path of one or more objects of the set of objects.

Aspect 4 is the method of aspect 3, wherein the location of the one or more objects includes at least one of ground, a wall, a floor, a ceiling, a building, a non-building structure, a parked vehicle, furniture, a pedestrian, an automated guided vehicle (AGV), or a drone; wherein the shape of the one or more objects includes at least one of a volume, a size, an orientation, a projected shape, or a radio detection and ranging (RADAR) cross-section (RCS); wherein the material of the one or more objects includes at least one of metal, brick, concrete, glass, wood, plastic, or flesh; wherein the material information of the one or more objects includes at least one of humidity, conductivity, or reflectivity; or wherein the expected signaling path power of the one or more objects includes at least one of a relative power to noise level or a relative power to line of sight (LOS) peak level.

Aspect 5 is the method of any of aspects 1 to 4, wherein the sensing operation is a monostatic sensing operation or a bistatic sensing operation.

Aspect 6 is the method of any of aspects 1 to 5, further comprising at least one of providing, for a network node, a request for the environmental information via at least one of first radio resource control (RRC) signaling, a first medium access control (MAC) control element (MAC-CE), or uplink control information (UCI); wherein obtaining the environmental information comprises: receiving, from the network node, the environmental information via: at least one of second RRC signaling, a second MAC-CE, or downlink control information (DCI) provided for the UE, or system information in a broadcast signal; or wherein obtaining the environmental information comprises: performing a channel estimation based on at least one sensing signal.

Aspect 7 is the method of aspect 6, wherein the request for the environmental information includes position information associated with the UE, and wherein the environmental information is based at least in part on the position information associated with the UE; or wherein the environmental information includes clutter information associated with the at least one unintended object in the set of objects.

Aspect 8 is the method of any of aspects 1 to 7, further comprising: sensing the at least one target object during the sensing operation in the sensing environment; processing the at least one target object based on the sensing operation; and providing, for a network node, a sensing indication that includes sensing information associated with the at least one target object based on the processed at least one target object.

Aspect 9 is the method of aspect 8, wherein the sensing indication is based on a sensing configuration and further includes at least one of a signaling path that (1) is within a delay range, (2) is within the delay range or an angle of arrival (AoA) range, (3) has a Doppler shift, (4) has a signaling path power that meets a power threshold, or (5) has a reflector unidentified in the environmental information.

Aspect 10 is the method of any of aspects 1 to 9, wherein the filtered data for the at least one unintended object in the set of objects is at least one of a time of arrival (ToA), an angle of arrival (AoA), a velocity, a Doppler shift, a micro-Doppler shift, or a signaling path power.

Aspect 11 is the method of any of aspects 1 to 10, further comprising: outputting an indication of the processed data for the at least one target object or the filtered data for the at least one unintended object; or wherein outputting the indication comprises at least one of: storing the indication of the processed data for the at least one target object or the filtered data for the at least one unintended object; or transmitting the indication of the processed data for the at least one target object or the filtered data for the at least one unintended object.

Aspect 12 is a method of wireless communication at a network node, comprising: providing, for a user equipment (UE), environmental information associated with a sensing environment, wherein the environmental information indicates at least one characteristic associated with a set of objects in the sensing environment, wherein the set of objects in the sensing environment includes at least one target object and at least one unintended object; and receiving, from the UE, a sensing indication that corresponds to a sensing operation, wherein the sensing indication includes sensing information associated with the at least one target object of the set of objects in the sensing environment based on the at least one target object.

Aspect 13 is the method of aspect 12, wherein the environmental information is associated with at least one of a previous sensing operation result, a priori information for the at least one unintended object, or a sensor of the network node; or wherein the at least one characteristic associated with the set of objects includes at least one of a location, a shape, a material, material information, or an expected signaling path power of at least one signaling path of one or more objects of the set of objects.

Aspect 14 is the method of aspect 13, wherein the location of the one or more objects includes at least one of ground, a wall, a floor, a ceiling, a building, a non-building structure, a parked vehicle, furniture, a pedestrian, an automated guided vehicle (AGV), or a drone; wherein the shape of the one or more objects includes at least one of a volume, a size, an orientation, a projected shape, or a radio detection and ranging (RADAR) cross-section (RCS); wherein the material of the one or more objects includes at least one of metal, brick, concrete, glass, wood, plastic, or flesh; wherein the material information of the one or more objects includes at least one of humidity, conductivity, or reflectivity; or wherein the expected signaling path power of the one or more objects includes at least one of a relative power to noise level or a relative power to line of sight (LOS) peak level.

Aspect 15 is the method of any of aspects 12 to 14, wherein the sensing operation is a monostatic sensing operation or a bistatic sensing operation.

Aspect 16 is the method of any of aspects 12 to 15, further comprising at least one of: receiving, from the UE, a request for the environmental information via at least one of first radio resource control (RRC) signaling, a first medium access control (MAC) control element (MAC-CE), or uplink control information (UCI); or wherein obtaining the environmental information comprises: receiving, from the network node, the environmental information via: at least one of second RRC signaling, a second MAC-CE, or downlink control information (DCI) provided for the UE, or system information in a broadcast signal.

Aspect 17 is the method of aspect 16, wherein the request for the environmental information includes position information associated with the UE, and wherein the environmental information is based at least in part on the position information associated with the UE; or wherein the environmental information includes clutter information associated with the at least one unintended object in the set of objects.

Aspect 18 is the method of any of aspects 12 to 17, wherein receiving the sensing indication comprises: receiving, from the UE, the sensing indication that includes the sensing information associated with the at least one target object based on processing the at least one target object; or wherein the method further comprises: receiving a data indication of processed data for the at least one target object or filtered data for the at least one unintended object.

Aspect 19 is the method of aspect 18, wherein the sensing indication is based on a sensing configuration and further includes at least one of a signaling path that (1) is within a delay range, (2) is within the delay range or an angle of arrival (AoA) range, (3) has a Doppler shift, (4) has a signaling path power that meets a power threshold, or (5) has a reflector unidentified in the environmental information.

Aspect 20 is an apparatus for wireless communication including means for implementing any of aspects 1 to 11.

Aspect 21 is a computer-readable medium (e.g., a non-transitory computer-readable medium) storing computer executable code, the code when executed by at least one processor causes the at least one processor to implement any of aspects 1 to 11.

Aspect 22 is an apparatus for wireless communication at a network node. The apparatus includes a memory; and at least one processor coupled to the memory and, based at least in part on information stored in the memory, the at least one processor is configured to implement any of aspects 1 to 11.

Aspect 23 is the apparatus of aspect 22, further including at least one of a transceiver or an antenna coupled to the at least one processor.

Aspect 24 is an apparatus for wireless communication including means for implementing any of aspects 12 to 19.

Aspect 25 is a computer-readable medium (e.g., a non-transitory computer-readable medium) storing computer executable code, the code when executed by at least one processor causes the at least one processor to implement any of aspects 12 to 19.

Aspect 26 is an apparatus for wireless communication at a network node. The apparatus includes a memory; and at least one processor coupled to the memory and, based at least in part on information stored in the memory, the at least one processor is configured to implement any of aspects 12 to 19.

Aspect 27 is the apparatus of aspect 26, further including at least one of a transceiver or an antenna coupled to the at least one processor.

What is claimed is:

1. An apparatus for wireless communication at a user equipment (UE), comprising:
a memory; and
at least one processor coupled to the memory and, based at least in part on information stored in the memory, the at least one processor is configured to:
obtain environmental information associated with a sensing environment;
detect, during a sensing operation, a set of objects in the sensing environment; and
process data for at least one target object in the set of objects or filter data for at least one unintended object in the set of objects based on the environmental information, wherein the environmental information indicates at least one characteristic associated with the set of objects in the sensing environment.

2. The apparatus of claim 1, wherein the environmental information is associated with at least one of a previous sensing operation result, a priori information for the at least one unintended object, or a sensor of a network node.

3. The apparatus of claim 1, wherein the at least one characteristic associated with the set of objects includes at least one of a location, a shape, a material, material information, or an expected signaling path power of at least one signaling path of one or more objects of the set of objects.

4. The apparatus of claim 3, wherein the location of the one or more objects includes at least one of ground, a wall, a floor, a ceiling, a building, a non-building structure, a parked vehicle, furniture, a pedestrian, an automated guided vehicle (AGV), or a drone;
wherein the shape of the one or more objects includes at least one of a volume, a size, an orientation, a projected shape, or a radio detection and ranging (RADAR) cross-section (RCS);
wherein the material of the one or more objects includes at least one of metal, brick, concrete, glass, wood, plastic, or flesh;
wherein the material information of the one or more objects includes at least one of humidity, conductivity, or reflectivity; or
wherein the expected signaling path power of the one or more objects includes at least one of a relative power to noise level or a relative power to line of sight (LOS) peak level.

5. The apparatus of claim 1, wherein the sensing operation is a monostatic sensing operation or a bistatic sensing operation.

6. The apparatus of claim 1, wherein the at least one processor is further configured to perform at least one of:
provide, for a network node, a request for the environmental information via at least one of first radio resource control (RRC) signaling, a first medium access control (MAC) control element (MAC-CE), or uplink control information (UCI);
wherein to obtain the environmental information, the at least one processor is configured to: receive, from the network node, the environmental information via:
at least one of second RRC signaling, a second MAC-CE, or downlink control information (DCI) provided for the UE, or
system information in a broadcast signal; or
wherein to obtain the environmental information, the at least one processor is configured to: perform a channel estimation based on at least one sensing signal.

7. The apparatus of claim 6, wherein the request for the environmental information includes position information associated with the UE, and wherein the environmental information is based at least in part on the position information associated with the UE; or
wherein the environmental information includes clutter information associated with the at least one unintended object in the set of objects.

8. The apparatus of claim 1, wherein the at least one processor is further configured to:
sense the at least one target object during the sensing operation in the sensing environment;
process the at least one target object based on the sensing operation; and
provide, for a network node, a sensing indication that includes sensing information associated with the at least one target object based on the processed at least one target object.

9. The apparatus of claim 8, wherein the sensing indication is based on a sensing configuration and further includes at least one of a signaling path that (1) is within a delay range, (2) is within the delay range or an angle of arrival (AoA) range, (3) has a Doppler shift, (4) has a signaling path power that meets a power threshold, or (5) has a reflector unidentified in the environmental information.

10. The apparatus of claim 1, wherein the filtered data for the at least one unintended object in the set of objects is at least one of a time of arrival (ToA), an angle of arrival (AoA), a velocity, a Doppler shift, a micro-Doppler shift, or a signaling path power.

11. The apparatus of claim 1, wherein the at least one processor is further configured to:
output an indication of the processed data for the at least one target object or the filtered data for the at least one unintended object;
wherein to output the indication, the at least one processor is configured to perform at least one of:
store the indication of the processed data for the at least one target object or the filtered data for the at least one unintended object; or
transmit the indication of the processed data for the at least one target object or the filtered data for the at least one unintended object.

12. An apparatus for wireless communication at a network node, comprising:
a memory; and
at least one processor coupled to the memory and, based at least in part on information stored in the memory, the at least one processor is configured to:
provide, for a user equipment (UE), environmental information associated with a sensing environment, wherein the environmental information indicates at least one characteristic associated with a set of objects in the sensing environment, wherein the set of objects in the sensing environment includes at least one target object and at least one unintended object; and
receive, from the UE, a sensing indication that corresponds to a sensing operation, wherein the sensing indication includes sensing information associated with the at least one target object of the set of objects in the sensing environment based on the at least one target object.

13. The apparatus of claim 12, wherein the environmental information is associated with at least one of a previous sensing operation result, a priori information for the at least one unintended object, or a sensor of the network node; or
wherein the at least one characteristic associated with the set of objects includes at least one of a location, a shape, a material, material information, or an expected signaling path power of at least one signaling path of one or more objects of the set of objects.

14. The apparatus of claim 13, wherein the location of the one or more objects includes at least one of ground, a wall, a floor, a ceiling, a building, a non-building structure, a parked vehicle, furniture, a pedestrian, an automated guided vehicle (AGV), or a drone;
wherein the shape of the one or more objects includes at least one of a volume, a size, an orientation, a projected shape, or a radio detection and ranging (RADAR) cross-section (RCS);
wherein the material of the one or more objects includes at least one of metal, brick, concrete, glass, wood, plastic, or flesh;
wherein the material information of the one or more objects includes at least one of humidity, conductivity, or reflectivity; or
wherein the expected signaling path power of the one or more objects includes at least one of a relative power to noise level or a relative power to line of sight (LOS) peak level.

15. The apparatus of claim 12, wherein the sensing operation is a monostatic sensing operation or a bistatic sensing operation.

16. The apparatus of claim 12, wherein the at least one processor is further configured to:
receive, from the UE, a request for the environmental information via at least one of first radio resource control (RRC) signaling, a first medium access control (MAC) control element (MAC-CE), or uplink control information (UCI); or
wherein to provide the environmental information, the at least one processor is configured to: provide, form the UE, the environmental information via:
at least one of second RRC signaling, a second MAC-CE, or downlink control information (DCI) provided for the UE, or
system information in a broadcast signal.

17. The apparatus of claim 16, wherein the request for the environmental information includes position information associated with the UE, and wherein the environmental information is based at least in part on the position information associated with the UE; or
wherein the environmental information includes clutter information associated with the at least one unintended object in the set of objects.

18. The apparatus of claim 12, wherein to receive, from the UE, the sensing indication, the at least one processor is configured to:
receive, from the UE, the sensing indication that includes the sensing information associated with the at least one target object based on processing the at least one target object; or
wherein the at least one processor is further configured to:
receive a data indication of processed data for the at least one target object or filtered data for the at least one unintended object.

19. The apparatus of claim 18, wherein the sensing indication is based on a sensing configuration and further includes at least one of a signaling path that (1) is within a delay range, (2) is within the delay range or an angle of arrival (AoA) range, (3) has a Doppler shift, (4) has a signaling path power that meets a power threshold, or (5) has a reflector unidentified in the environmental information.

20. A method of wireless communication at a user equipment (UE), comprising:
obtaining environmental information associated with a sensing environment;
detecting, during a sensing operation, a set of objects in the sensing environment; and
processing data for at least one target object in the set of objects or filtering data for at least one unintended object in the set of objects based on the environmental information, wherein the environmental information indicates at least one characteristic associated with the set of objects in the sensing environment.
